(19) United States
(12) Patent Application Publication
(10) Pub. No.: US 2015/0074705 A1
(43) Pub. Date: Mar. 12, 2015

(54) PARENTAL MONITORING IN A HOME GATEWAY ENVIROMENT

(71) Applicant: Mark Francis Rumreich, Indianapolis, IN (US)

(72) Inventor: Mark Francis Rumreich, Indianapolis, IN (US)

(73) Assignee: THOMSON LICENSING

(21) Appl. No.: 14/389,989

(22) PCT Filed: May 30, 2012
(86) PCT No.: PCT/US12/39941

§ 371 Date: Oct. 1, 2014

(51) Int. Cl. H04N 21/442; H04N 21/422; H04N 21/6587; H04N 21/24; H04N 21/8549; H04N 21/433; H04N 21/436; H04L 12/28; H04N 21/466

(52) U.S. Cl. CPC H04N 21/44204; H04L 12/28; H04N 21/42204; H04N 21/6587; H04N 21/4667; H04N 21/8549; H04N 21/4334; H04N 21/43615; H04N 21/43622; H04N 21/2402; H04N 21/44209; H04N 21/44227
USPC 725/21; 725/14

(57) ABSTRACT

The methodologies, systems and teachings disclosed herein can be embodied in gateway device that is capable of monitoring content accessed through the gateway device. Captures of screen content of the content accessed are obtained and a log of the content accessed is generated from the captured screen content. The log can then be displayed to a user who can use a remote control to navigate through the log to view the captured screen content at different instances of time.

### BACKGROUND

1. Technical Field

This invention relates to the field of home gateways. More particularly, this invention relates to the ability to monitor activity through a home gateway.

2. Description of Related Art

With the abundance of movie and music content available through a delivery mechanism as the internet, parents have a difficult time knowing about what their children watch and listen to. Some of the material that children have access to may be sexual or offensive in nature, such that parents may not want their children to be exposed to such material. Moreover, parents may also want to restrict their children from being able to access websites and other communication media which can expose children to unsuitable material.

One current solution involves filtering or blocking objectionable content. These solutions typically rely on ratings or lists of keywords or websites. The problem with this type of solution is that the filtering is static and passive. Once set-up, filtering and blocking are based on fixed and pre-established rules. Because the content accessed is fluid in nature and can change constantly, these solutions can be overly restrictive or not restrictive enough.

Another solution is monitoring programs that create a log file of the history of websites visited. The problem with that type of solution is that is also passive and static. The web browsing history is logged providing a list of web addresses visited. While this can give general information as to what web sites were visited it does not account for what content was being displayed on the website visited. Again, since the content being accessed is fluid in nature, the content being viewed when a child visited a website may not be the same content being displayed on the website when the log of the history of websites visited by the child is being reviewed.

Since content being accessed through a gateway device is fluid in nature and can change over time, it is advantageous to be able to capture and log the content itself at the time the content is being accessed. Thus, when a parent reviews the log of content accessed, they are able to see exactly what content was accessed.

### SUMMARY

In accordance with one embodiment, a method is provided for parental monitoring in a gateway device. This involves monitoring content accessed through the gateway device. Captures of screen content of the content accessed through the gateway device are then obtained and stored. A log of content accessed through the gateway device is then generated from the captures screen content. In certain embodiments, the log can be navigated by a user using a remote control. For example, the rewind and fast forward commands may be used to navigate through the screen captures from different times.

With this methodology a parent has a convenient way to review the content that was accessed by a child at different times with the screen captures accurately displaying the actual content that was viewed by the child at a particular point in time.

In accordance with another embodiment, a gateway device is provided for the monitoring of content accessed through the gateway device. The system involves a receiver, a processor, storage and an output interface. The receiver is configured to the receive service provided by a service provider over a broadband connection. The processor is configured to monitor content accessed through the gateway device, capture screen content of the content accessed through the gateway device, storing the captured screen content, and generate a log of the content accessed through the gateway devices from the screen captures. The storage is for storing the captured screen content. The input/output interface is configured to provide access to the content available through the gateway device and the log of the content accessed through the gateway device.

### BRIEF DESCRIPTION OF THE DRAWINGS

FIG. 1 is a diagram depicting an embodiment of a home network using including a gateway device having the functionality describe herein in accordance with the present disclosure.

FIG. 2 is a block diagram useful depicting the elements of a gateway device in accordance with one embodiment of the present disclosure.

FIG. 3 is a flow diagram illustrating a methodology in accordance with one embodiment of the present disclosure.

FIG. 4 is a screen shot of a log of content accessed through the gateway generated in accordance with one embodiment of the present disclosure.

FIG. 5 is a flow diagram illustrating additional steps of a methodology in accordance with an embodiment of the present disclosure.

### DETAILED DESCRIPTION

The methodologies, systems and teachings disclosed herein can be embodied in a gateway device that is capable of monitoring content accessed through the gateway device. Screen content of the content accessed are captured and a log of the content accessed is generated from the captured screen content. The log may then be displayed to a user who may use a remote control to navigate through the log to view the screen captures of content as different instances of time.

In the examples described herein, the term “gateway” is used refer to the a device that can serve as a central distribution hub for services provided by a service provider that are in turn distributed to other devices in communication with the gateway device. For example, a gateway device can serve to distribute television, telephone, and internet service provided over a broadband connection other devices in such as display devices, set top boxes, personal computers, and telephones that are in communication with the gateway device. In some cases the gateway device may include additional functionality such as Digital Video Recorder (DVR) functionality and network routing and switching functionality.

The term “content” is used herein to refer to the data that can be accessed through the gateway device. This includes television shows, movies, music, sports or music events, websites, podcasts, streaming media, telephone calls, instant messages or any other data that can be accessed through a gateway device including data that may be stored on the gateway device itself. Screen content refers to text or images that appear on a display device. Captured screen content my include still-screen, videos, text files, or a combination thereof. Captured screen content may represent images, video, audio, data, and the like.

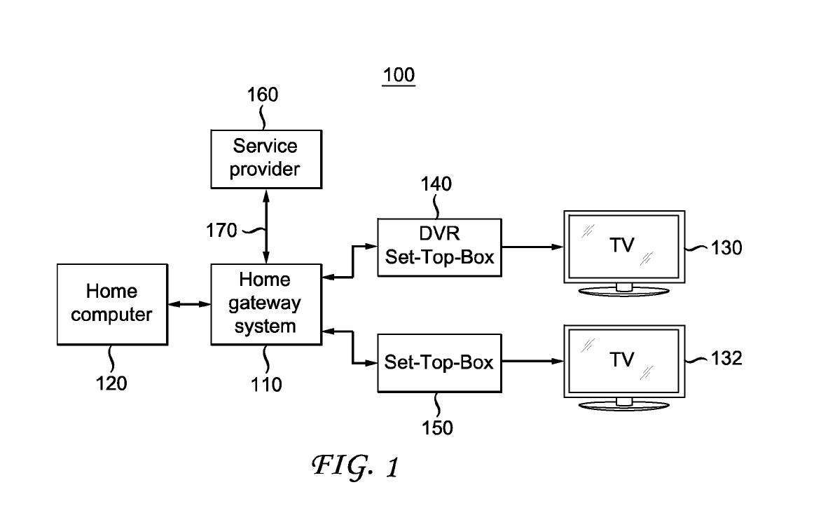

FIG. 1 depicts one environment 100 in which a gateway device with the functionality described herein can be employed. In this embodiment, a gateway device 110 is connected to other devices in a user home such as a home computer 120, and televisions 130 and 132 through set top boxes 140 and 150.

The gateway device 110 is configured to receive content from one or more service providers 160 over a connection 170 such as, but not limited to, a broadband connection. The service provider 160 can provide a number of services such as, but not limited to, television, telephone, and internet services over a broadband connection 170. Examples of broadband connections include, but are not limited to, cable, fiber optic, and wireless connections. In some embodiments, the gateway device 110 can be connected to multiple service providers 160 over multiple broadband connections 160. In such embodiments, different services can be provided by the different service providers.

The gateway device 110 is designed to distribute the services provided by the service provider 160 as well as the content provided by the services to other devices in communication with the gateway device 110. Thus, the other devices access content provided as part of the services through the gateway device 110. In the example of FIG. 1, the gateway device is in communication with a home computer 120 as well as a DVR set top box 140 and a non-DVR set top box 150 which are in turn connected to display devices 130 and 132. The communication to these devices can be provided over network connections or other types of data connections. For example, the communication between the gateway device 110 and the home computer 120 can be provided over an Ethernet or wireless network wherein the home computer 120 uses the Ethernet or wireless connection to access internet content through the gateway device 110. The communication between the gateway 110 and the set top boxes 140 and 150 on the other hand can use a multimedia over coaxial (MoCa) network connection wherein the set top boxes 140 and 150 use the MoCa network connection to communicate with the gateway device 110. The set top boxes 140 and 150 in turn can distribute content received from the gateway devices 110 to the display devices 130 and 132 using a coaxial, RCA, HDMI, or other AV connection. Other suitable connection for communication between the gateway 110 and other devices will be apparent to one skilled in the art given the benefit of this disclosure.

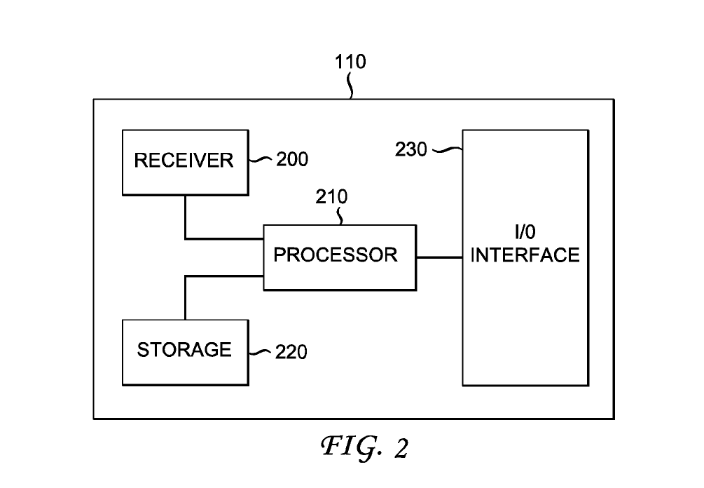

FIG. 2 is a block diagram depicting the elements of gateway device 110 in accordance with one embodiment of the present disclosure. In this embodiment, the gateway device 110 includes a receiver 200, a processor 210, storage 220, and an input/output interface 230. Each of these elements will be discussed in more detail below.

The receiver 200 is configured to receive content provided as part of the one or more services received from a service provider 160 over broadband connection 170. The content can any type of data provide as part of television, internet, or telephone services. The type and configuration of the receiver 200 depends on the source and format of the content. As such, the receiver can be configured to receive television, internet, or telephone content or any combination thereof. The receiver 200 allows the gateway device 110 to access and decode the content that is provided as part of the various received services. As such, the receiver 200 can contain the necessary functionality to receive and decode the different services provided over a broadband connection such as television, internet, and telephone service. In the case of multiple service providers and multiple broadband connections the receiver 200 can contain multiple instances of the functionality to receive and decode the services provided by each service provider.

The processor 210 controls the operation of the gateway device 110. The processor runs the software that operates the gateway device 110 as well as provides the functionality of the parental monitoring. This includes receiving and monitoring the content accessed through the gateway device, capturing and storing screen content of the content accessed through the gateway device, and generating a log of the content accessed through the gateway device from the captured screen content. The processor 210 is connected to the receiver 200, storage 220, and an input/output interface 230, and handles the transfer and processing of information between these elements. The processor 210 can be a general processor or a processor dedicated for a specific functionality. In certain embodiments there can be multiple processors.

The storage 220 is where the software and other information used by the gateway device 110 are stored. The storage 220 can include volatile memory (RAM), non-volatile memory (EEPROM), magnetic media (hard drive), optical media (CD/DVD-Rom), or flash based storage. In certain embodiments the storage 220 will typically include memory as well as large capacity storage such as a hard-drive where obtained screen captures can be stored. Storage 220 may be a single storage device or multiple storage devices.

The input/output (I/O) interface 230 is configured to handle the communication between the gateway device 110 and other devices in communication with the gateway device 110. The I/O interface 230 allows the other devices to access the content available through the gateway device 110 as the generated log of content accessed through gateway device. The I/O interface 230 also handles providing the content or generated log in the correct format for the specific device. As such, the I/O interface 230 can network connectivity for connecting the gateway device to the other devices such as a home computer or set top boxes over a home network and/or the internet as described in regards to FIG. 1.

It should be understood that the elements set forth in FIG. 2 are illustrative. The gateway device 110 can include any number of elements and certain elements can provide part or all of the functionality of other elements. For example, much of the functionality of the receiver 200, and I/O interface 230 can be performed by the processor 210 or multiple general or dedicated processors. Alternately, the gateway device 110 can be part of or include the functionality of another device such as a set top box or DVR. Other possible implementation will be apparent to one skilled in the art given the benefit of the present disclosure.

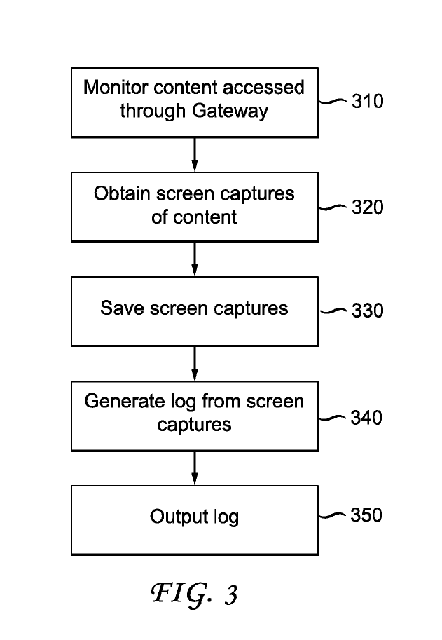

FIG. 3 is a flow diagram depicting a method 300 for the parental monitoring on gateway device. At its most basic, the method involves four steps. The first step is monitoring content accessed through the gateway device (step 310). Screen content of the content accessed through the gateway device is then captured (step 320). The captured screen content is then stored (step 330). A log of content accessed through the gateway is generated from the captured screen content (step 340). In certain embodiments, the method can further include the steps of outputting the log to a display device (step 350). Each of these steps will be discussed in more detail below.

In step 310, the content accessed through the gateway device is monitored. Since all the other devices, such as the home computer 120 and set top boxes 140 and 150, access the content provided as part of the services received through the gateway device 110, gateway 110 can also have access to the content. For example, web sites and other internet date sent and received by the home computer 120 through the gateway 110 can be tracked by the gateway 110. Similarly, television programming and streaming or downloaded content is also provided through the gateway 110 to the set top boxes 140 and 150 and thus can be tracked by the gateway 110. In other embodiments, in order to monitor the content accessed through the gateway, the gateway 110 can use information from the service provider 160 or the device in communication with the gateway 110 to determine what content has been accessed. For example, the gateway 110 can receive information regarding the internet data or on-demand movies requested from the service provider. Likewise, the computer 120 or set top boxes 140 and 150 can provide information regarding the websites visited or programs watched. This information can be provided automatically or in response to a request from the gateway device 110. In some such embodiments, the service provider or other device can have an application running locally that transmits the information automatically or in response to a request.

In step 320, screen content of the content accessed through the gateway device 110 is captured. In certain embodiments, the capturing of the screen content can involve the gateway device 110 itself capturing the screen content based on the content being monitored (step 310). In other embodiments, the screen content can be captured by the devices accessing the content through the gateway device. One example includes the home computer 120 capturing screen content of the websites being viewed or videos being streamed on the home computer 120. Another example includes the set top devices 140 and 150 capturing screen content of the programs being viewed on the set top boxes 140 and 150. The capturing of screen content on the devices accessing the content can be automatic or in response to a request from the gateway device 110. In some embodiments, the computer 120 or set top boxes 140 and 150 can have an application running locally that captures and transmits the screen content automatically or in response to a request.

In certain embodiments, the time the screen content was captured as well as the device accessing the content depicted in the screen content is noted when the screen content is captured. In some embodiments, this can be included as part of the captured screen content, for example, as a time stamp or as part of the data file.

In some embodiments, the capturing of screen content can be periodic in nature. That is, screen content is captured every few minutes or other designated period of time. In certain embodiments, the frequency and type of capturing can change based on storage limitations, the content being accessed, the device accessing the content, or any combination thereof. In other embodiments, the capturing of screen content can be triggered by an event, such as request from the gateway device 110, a certain type of content being accessed as determined in the monitoring step (step 310), a certain device accessing content, or any combination thereof. In yet other embodiments, the time period or events set to trigger screen capture can be set by a user (e.g., a parent) in control of the network environment 100.

After captures of screen content have been obtained (step 320), they are stored (step 330). In certain embodiments, the captured screen content is stored in the storage 220 of the gateway 110. In some cases, the gateway 110 can include or be part of a home server or DVR, in which case the gateway device 110 can have access to the additional storage space provided for the home server back-up or DVR functionality in order to store the captured screen content. In other embodiments, the captured screen content can be stored on other storage devices in communication with the gateway 110. For example, the captured screen content can be stored on the DVR set top box 140. The associated time and device information for captured screen content can also be stored on the DVR set top box 140.

With the captured screen content stored (step 330), a log of the content being accessed through the gateway can be generated from the stored captured screen content. In some embodiments, the generation of the log can be automatic with the log updated as captured screen content is received. In other embodiments, the log can be generated dynamically from the stored captured screen content in response to a request for a log of content accessed through the gateway device 110.

In certain embodiments, the log can include all the captured screen content of all the content access through the gateway device 110 by all the devices in communication with the gateway device 110. In such embodiments, each piece of captured screen content in the log can be provided with additional information indicating which device the captured screen content relates to. In other embodiments, a log can be generated for each device, wherein the log only includes captured screen content related to the specific device the log is for.

In some embodiments, the log consists of the captured screen content arranged in chronological order, wherein captured screen content of content accessed through the gateway device 110 at different times can be viewed by moving forward or backwards through the chronologically ordered log.

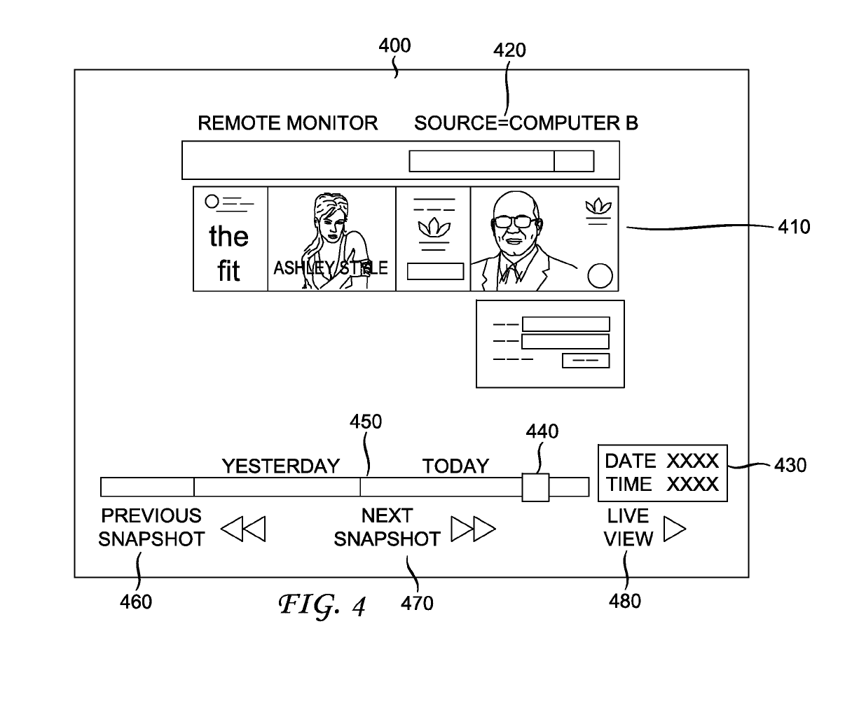

Once the log has been generated (step 340) it can be outputted on a display device (step 350). For example, a generated log can viewed on the monitor of the computer 120 or on the display device 130 and 132 via the set top boxes 140 and 150 in communication with the gateway device 110. An example of a displayed log 400 can be seen in FIG. 4.

In the embodiment of FIG. 4, the displayed log 400 provides stills of captured screen content 410 presented in chronological order. The displayed log 400 also includes indicators for the source 420, in this case “Computer B,” and the date and time 430 of captured screen content 410. In this embodiment, the displayed log 400 also includes an indicator 440 of where a particular still of captured screen content exists in the timeline of the chronologically presented captured screen content represent by time bar 450.

In certain embodiments, a user can navigate the log 400 by using remote control commands similar to those used when operating a DVR or DVD player. For example, in FIG. 4, on screen displays 460, 470 and 480 indicate that the rewind command can be used to navigate to the previous still of captured screen content, the fast forward command can be used to navigate to the next still of captured screen content, and the play can be used to navigate to a live capture of screen content of the content being accessed by “Computer B.”

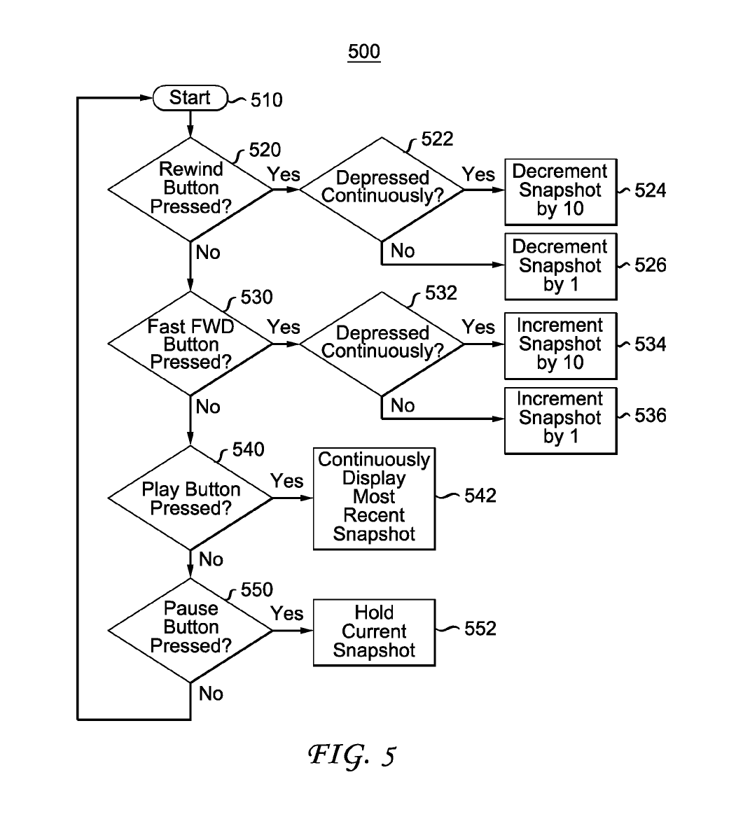

In some embodiments, in addition to using standard remote control commands to navigate the log 400, enhanced or so-called “Trick Play” functionality can also be supported for navigating the log 400. An example of this can be seen in FIG. 5.

FIG. 5 is a flow diagram 500 depicting one embodiment for of how “trick play” functionality could be implemented for navigating a log 400. Upon starting the flow diagram (block 510) it is determined if the rewind button has been pressed (decision block 520). If the rewind button has been pressed, it is determined if the rewind button has been depressed continuously (decision block 522). If the rewind button has been depressed continuously, then the log 400 is navigated backward ten still screen captures in the chronological arrangement of the screen captures (block 524). If the rewind button has not been depressed continuously, then the log 400 is navigated backward only one still screen capture in the chronological arrangement of the still screen captures (block 524). However, if it is determined that the rewind button has not been pressed, the next determination is made (decision block 530).

The next determination in the flow diagram 500 is whether the fast forward button has been pressed (decision block 530). If the fast forward button has been pressed, it is determined if the fast forward button has been depressed continuously (decision block 532). If the fast forward button has been depressed continuously, then the log 400 is navigated forward ten still screen captures in the chronological arrangement of the screen captures (block 534). If the fast forward button has not been depressed continuously, then the log 400 is navigated forward only one still screen capture in the chronological arrangement of the screen captures (block 524). However, if is determined that the fast forward button has not been pressed, the next determination is made (decision block 540).

The next determination in the flow diagram 500 is whether the play button has been pressed (decision block 540). If the play button has been pressed, then the log is navigated to the most recent still screen capture (block 542). However, if is determined that the play button has not been pressed, the next determination is made (decision block 550).

The next determination in the flow diagram 500 is whether the pause button has been pressed (decision block 550). If the pause button has been pressed, then the log is maintained at currently displayed still screen capture (block 552). However, if is determined that the pause button has not been pressed, progression through the flow diagram begins again (block 510).

Thus, “trick play” rewind and fast forward as well as play and pause functionality can be implemented to navigate the log 400.

It should be noted that, although the examples above in regard to FIGS. 4 and 5 deal with still screen captures, a similar technique could be used to review captured videos wherein the captured videos are represented in the log by thumbnails generated from the captured video. Other possible configurations and implementations will be apparent to one skilled in the art given the benefit of the present disclosure.

It should be understood that the set-up and management of the parental monitoring features in the gateway device 110 including the content monitoring, capturing of screen content, and generation of a log can be performed by the user as needed. For example, on-screen menus can be provided to a user to configure or modify any of these aspects.

While the examples set forth above has focused on an electronic device, it should be understood that the present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

1. A method comprising:
monitoring content accessed through a gateway device;
capturing screen content accessed through the gateway device;
storing the captured screen content accessed though the gateway device; and
generating a log of content accessed through the gateway device from the captured screen content for subsequent display.

2. The method of claim 1, further comprising the step of:
outputting the generated log to a display device.

3. The method of claim 1, wherein the step of storing the captured screen content comprises storing the screen captures on a DVR in communication with the gateway device.

4. The method of claim 1, wherein the generated log of content accessed through the gateway device can be navigated using a remote control.

5. The method of claim 4, wherein the navigation using the remote control comprises using rewind and fast forward functionality.

6. The method of claim 5, wherein the navigation comprises trick play rewind and fast forward functionality.

7. The method of claim 1, wherein the content accessed through the gateway device being monitored is websites and the captured screen content is of websites visited.

8. The method of claim 1, wherein the content accessed through the gateway device being monitored is television programs and the captured screen content is of the programs viewed.

9. The method of claim 1, wherein the content accessed through the gateway device being monitored is streaming video and the captured screen content is of the streaming video.

10. The method of claim 1, wherein the step of capturing screen content comprises obtaining capturing screen content periodically.

11. The method claim 1, wherein the step of capturing screen content comprises capturing screen content based the content accessed through the gateway device.

12. The method claim 1, wherein the step of capturing screen content comprises capturing screen content using a device in communication with the gateway device.

13. The method of claim 12, wherein the device in communication with the gateway device captures the screen content from the content accessed on the device and provides the captured screen content to the gateway device.

14. The method of claim 1, wherein the step of generating a log of the content accessed through the gateway device comprises generating a log for each device that accessed content though the gateway device.

15. A gateway device comprising:
a receiver configured to receive content accessible through the gateway device
a processor configured to monitor content accessed through the gateway device, capture screen content of the content accessed through the gateway device, store the captured screen content, and generate a log of the content accessed through the gateway devices from the captured screen content;
storage for storing the captured screen content;
an interface for providing access to content available through the gateway device and the log of the content accessed through the gateway device.

16. The gateway device of claim 15, wherein the interface further comprises network connectivity.
